(19) United States
(12) Patent Application Publication
(10) Pub. No.: US 2008/0211743 A1
(43) Pub. Date: Sep. 4, 2008

(54) Plasma display device and driving method of plasma display panel

(76) Inventors: Byung-Gwon Cho, Suwon-si (KR); Jeong-Hoon Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/009,268

(22) Filed: Jan. 17, 2008

(30) Foreign Application Priority Data
Jan. 17, 2007 (KR) 10-2007-005319

(51) Int. Cl. G09G 3/28

(52) U.S. Cl. 345/68

(57) ABSTRACT

A driving method of a plasma display panel including a plurality of first electrodes, a plurality of second electrodes, and a plurality of third electrodes formed in a direction to be intersected with the first electrodes and the second electrodes is disclosed. The method includes resetting the electrodes by applying a waveform having a predetermined voltage to the first electrode, applying a fourth voltage to the second electrodes for a predetermined period; selecting cells to be discharged by applying a scan pulse voltage to each of the first electrodes and the third electrodes; and alternately applying a plurality of sustain discharge pulses having a first voltage as peak value to each of the first electrodes and the second electrodes, wherein the step of applying the fourth voltage Ve stops the application of the fourth voltage Ve while the first sustain discharge pulse of the first electrodes continues.

### CROSS-REFERENCE TO RELATED APPLICATIONS

This application claims the benefit of Korean Patent Application No. 10-2007-0005319, filed on Jan. 17, 2007, in the Korean Intellectual Property Office, the disclosure of which is incorporated herein by reference.

### BACKGROUND

1. Field of the Invention

The present invention relates to a plasma display device and a driving method of a plasma display panel.

2. Description of the Related Technology

A plasma display device is a flat panel display device which displays characters or images by using the plasma generated by means of gas discharge, wherein more than several tens to several millions pixels are arranged in a matrix depending on the size of the plasma display device. In a panel of such a plasma display device, on one surface thereof are formed scan electrodes and sustain electrodes parallel with each other and on the other surface thereof is formed an address electrode in a direction orthogonal to the scan and sustain electrodes. Further, the sustain electrodes are formed to be corresponded to the respective scan electrodes and one end thereof are commonly connected to each other.

According to the driving method of a general plasma display device, one frame is divided into a plurality of subfields. The respective subfields have a reset period, an address period, and a sustain period. The reset period is the period to initialize the state of each cell so that an addressing operation is smoothly performed on cells, and the address period is the period where turned-on cells and turned-off cells on the panel are selected so that wall charges are accumulated on the turned-on cells. The sustain period is the period to perform the discharge in order to actually display an image on the cells to be turned-on.

During the address period, a scan pulse is applied to the respective address electrodes and scan electrodes of the turned-on cells to generate an address discharge so that the turned-on cells are prepared to generate a sustain discharge by accumulating positive (+) charges on Y electrodes, and accumulating negative (−) charges on X electrodes and A electrodes. However, when the absolute value of the scan pulse VscL applied to the Y electrodes during the address period is too large, the amount of the positive (+) charge and the negative charge (−) accumulated on the respective Y electrodes and A electrodes is excessive so that in the subsequent sustain period, counter discharge between the Y electrodes and the A electrodes is generated in addition to the surface discharge between the Y electrodes and the X electrodes, causing a phenomenon that the discharge becomes unstable.

### SUMMARY OF CERTAIN INVENTIVE ASPECTS

One aspect is a method of driving a plasma display panel, the display panel including a plurality of first electrodes, a plurality of second electrodes, a plurality of third electrodes, the third electrodes formed in a direction substantially perpendicular to the first electrodes and the second electrodes, and a plurality of discharge cells each formed near an intersections of the third electrodes and the first and second electrodes. The method includes resetting the discharge cells by applying a waveform to the first electrode, applying a fourth voltage to the second electrodes, selecting cells to be discharged by applying a scan pulse voltage to each of the first electrodes and the third electrodes corresponding to cells to be selected, alternately applying a plurality of sustain discharge pulses having a first voltage as a peak value to each of the first electrodes and the second electrodes, and while the first sustain discharge pulse of the first electrodes continues, stopping the application of the fourth voltage to the second electrodes.

Another aspect is a method of driving a plasma display panel, the display panel including a plurality of first electrodes, a plurality of second electrodes, a plurality of third electrodes, the third electrodes formed in a direction substantially perpendicular to the first electrodes and the second electrodes, and a plurality of discharge cells each formed near an intersections of the third electrodes and the first and second electrodes. The method includes resetting the discharge cells by applying a waveform to the first electrode, applying a fourth voltage to the second electrodes, selecting cells to be discharged by applying a waveform to the first electrodes and the third electrodes corresponding to cells to be selected, alternately applying a plurality of sustain discharge pulses to each of the first electrodes and the second electrodes, and stopping the application of the fourth voltage at substantially the same time the first sustain discharge pulse applied to the first electrodes reaches its peak value.

Another aspect is a plasma display device. The device includes a plasma display panel, including a plurality of first electrodes, a plurality of second electrodes, a plurality of third electrodes the third electrodes formed in a direction substantially perpendicular to the first electrodes and the second electrodes, and a plurality of discharge cells each formed near an intersections of the third electrodes and the first and second electrodes. The device also includes a driving apparatus configured to apply a fourth voltage to the second electrodes, alternately apply a plurality of sustain discharge pulses, each having a first voltage as a peak value to each of the first electrodes and the second electrodes, and while the first sustain discharge pulse of the first electrodes continues, to stop the application of the fourth voltage to the second electrodes.

### BRIEF DESCRIPTION OF THE DRAWINGS

These and/or other aspects and advantages will become apparent and more readily appreciated from the following description of the preferred embodiments, taken in conjunction with the accompanying drawings of which:

FIG. 1 is a structural diagram of a three-electrode surface discharge AC type plasma display panel;

FIG. 2 is a block diagram showing a driving apparatus of a plasma display panel;

FIG. 3 is a driving waveform diagram of a plasma display device according to one embodiment; and

FIG. 4 is a driving waveform diagram of a plasma display device according to another embodiment.

### DETAILED DESCRIPTION OF CERTAIN INVENTIVE EMBODIMENTS

Hereinafter, certain embodiments will be described with reference to the accompanying drawings.

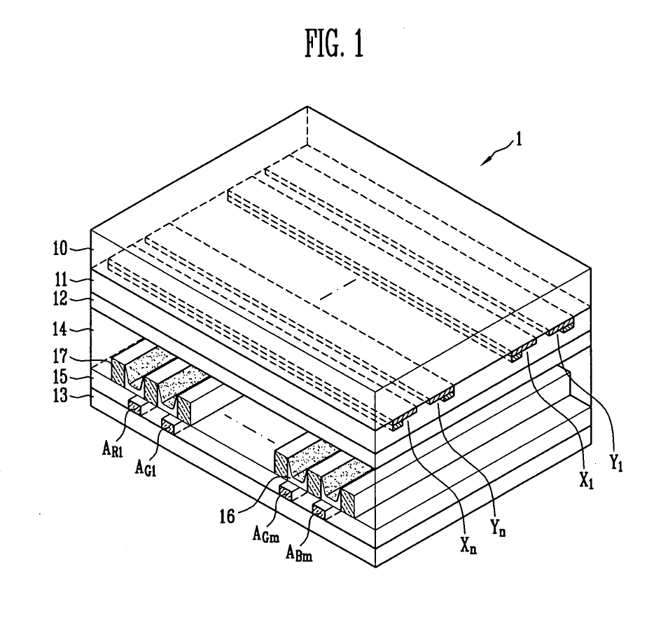

FIG. 1 shows an embodiment of a structure of a three-electrode surface discharge AC type plasma display panel.

Between front and rear glass substrates 10 and 13 of a plasma display panel 1, address electrode lines AR1, AG1, . . . AGm, ABm, dielectric layers 11 and 15, scan electrodes Y1, . . . Yn and sustain (common) electrodes X1, . . . Xn arranged to be paired and parallel with each other in a direction substantially perpendicular to the address electrodes, and a Magnesium Oxide (MgO) layer as a protective layer are positioned. Also, barrier ribs 17 partitioning the address electrode lines are installed, wherein on each of the barrier ribs are coated with fluorescent material 16 so that R, G, and B visible rays are radiated.

In a driving method which may be applied to such a plasma display panel, a reset step, an address step, and a sustain step are sequentially performed in a unit sub-field. In the reset step, the charge states of all display cells become uniform. In the address step, a wall voltage is generated in the selected display cells. In the sustain step, the display cells having the wall voltage generate a sustain discharge in response to an AC voltage to the pairs of XY electrode lines. In the sustain step, plasma is formed in a discharge space 14 of the selected display cells to generate the sustain discharge, and the fluorescent layer is excited by the radiation of ultraviolet rays of the discharge so that light is generated.

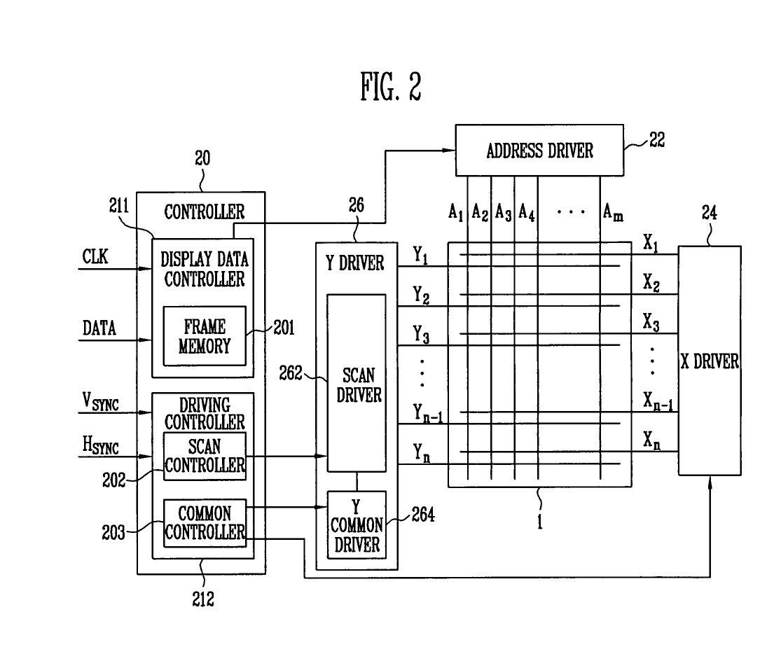

FIG. 2 is a block diagram showing an embodiment of a driving apparatus of a plasma display panel.

The plasma display panel includes a plurality of scan electrodes, a plurality of sustain electrodes and a plurality of address electrodes formed in a direction to be intersected with the scan electrodes and the sustain electrodes, a driving apparatus including a Y driver 26 driving the plurality of scan electrodes, an X driver 24 driving the plurality of sustain electrodes, an address driver 22 driving the plurality of address electrodes, and a controller 20 generating and then transmitting scan signals, sustain discharge signals and address signals to each driver. The controller 20 includes a display data controller 211 and a driving controller 212, the display data controller 211 includes a frame memory 201, and the driving controller 212 includes a scan controller 202 and a common controller 203. The Y driver 26 includes a scan driver 262 and a Y common driver 264.

The controller 20 receives clock signals CLK, data signals DATA, vertical synchronizing signals V_{SYNC}, and horizontal synchronizing signals H_{SYNC}. The display data controller 211 stores the data signals DATA in the internal frame memory 201 according to the clock signals CLK to input the corresponding address control signals to the address driver 22.

The driving controller 212, which processes the vertical synchronizing signals V_{SYNC} and the horizontal synchronizing signals H_{SYNC}, includes the scan controller 202 and the common controller 203. The scan controller 202 generates signals controlling the scan driver 262, and the common controller 203 generates signals controlling the Y common driver 264 and the X driver 24. The address driver 22 processes the address control signals from the display data controller 211 to apply the corresponding display data signals in the address step to the address electrode lines A1, . . . Am of the panel 1. The scan driver 262 of the Y driver 26 applies the corresponding scan driving signals to each of the scan electrodes Y1, . . . Yn in the address step according to the control signals from the scan controller 202. The Y common driver 264 of the Y driver 26 applies the common driving signals to the Y electrode lines Y1, . . . Yn in the sustain discharge step according to the control signals from the common controller 212. The X driver 24 applies the common driving signals to the X electrode lines X1, . . . Xn in the sustain discharge step according to the control signals from the common controller 203.

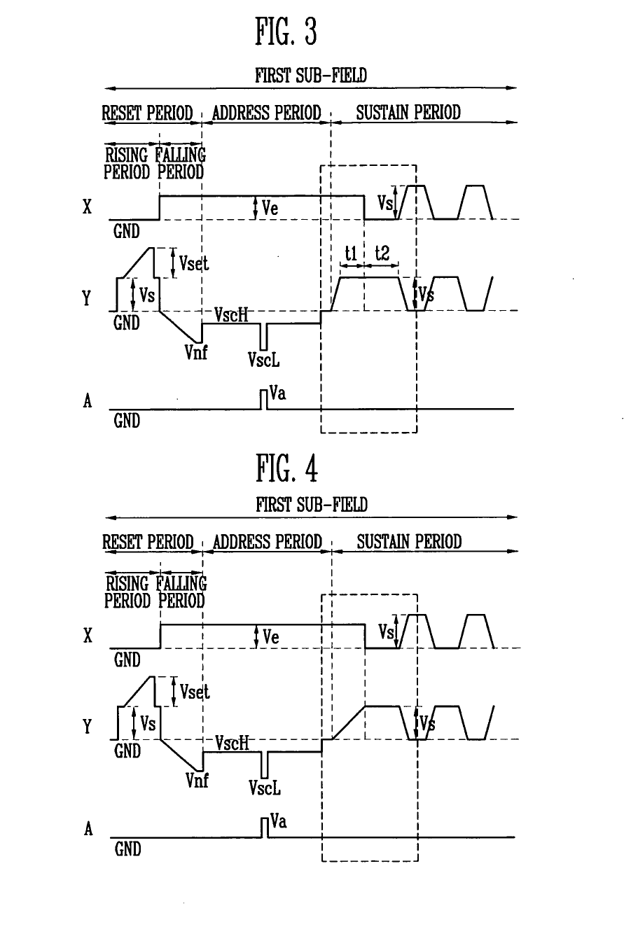

FIG. 3 is a driving waveform diagram of a plasma display device according to one embodiment.

A first sub-filed is constituted by a reset period, an address period, and a sustain period, wherein the reset period includes a rising period and a falling period.

First, in the rising period of the reset period in a first sub-field, a scan electrode Y is increased from a first voltage Vs to a second voltage Vset. As a result, weak reset discharge occurs from the scan electrode Y to an address electrode A and a sustain electrode X, respectively.

And, in the falling period of the reset period in the first sub-field, the scan electrode Y is decreased from the first voltage Vs to a third voltage Vnf. During the falling period of the reset period in the first sub-field, a ground voltage is applied to the address electrode A, and a fourth voltage Ve, which is larger than the ground voltage and smaller than the first voltage Vs, is applied to the sustain electrode X. While the voltage of the scan electrode Y is decreased, weak reset discharge occurs between the scan electrode Y and the sustain electrode X, and between the scan electrode Y and the address electrode A.

In the address period of the first sub-field, in order to select the discharged cells, scan pulses having a fifth voltage VscL are sequentially applied to the scan electrodes, and other scan electrodes not applied with the fifth voltage VscL are biased into a sixth voltage VscH.

In addition, scan pulses having a seventh voltage Va are applied to the address electrode A of the discharge cells which are selected by the scan electrode Y to which the fifth voltage VscL is applied, where the address electrodes A not selected are biased with a reference voltage.

An address discharge occurs in the discharge cells near the intersection of the address electrode A to which the seventh voltage Va is applied and the scan electrode Y to which the fifth voltage VscL is applied. When the absolute value of the fifth voltage VscL is large, the difference of the wall voltage between the address electrode A and the scan electrode Y becomes large as a result of the address discharge, causing a problem that counter discharge occurs during the subsequent sustain discharge period. In particular, the case where the absolute value of the fifth voltage VscL is larger than that of the first voltage Vs, counter discharge becomes a problem.

To this end, contrary to a general driving method, the present method includes applying the fourth voltage Ve, which is applied to the sustain electrode X during the reset period and the address period, for at least a portion of the sustain period.

The method alternately applies a plurality of sustain discharge pulses to the scan electrode Y between 0V and the first voltage Vs, and applies a plurality of sustain discharge pulses to the sustain electrode X between 0V and the first voltage Vs.

However, the pulse width of a first sustain discharge pulse applied to the scan electrode Y is longer than those of other sustain discharge pulses, and the fourth voltage Ve applied to the sustain electrode X is applied partially overlapping with the first sustain discharge pulse. As shown, the application of the fourth voltage Ve is stopped during the application of the first sustain discharge pulse of the first electrode.

With the method described as above, the counter discharge between the scan electrode Y and the address electrode A generated in the sustain interval is reduced.

As shown in FIG. 3, an interval t1 where the first sustain discharge pulse of the scan electrode Y overlaps the fourth voltage Ve applied to the sustain electrode X is shorter than an interval t2 when the first sustain discharge pulse of the scan electrode Y and the fourth voltage Ve do not overlap. The application of the fourth voltage is stopped before the first sustain discharge pulse of the first electrode reaches the point of ½ of the first pulse width.

In order to apply such a driving waveform, the controller 20 stops the application of the fourth voltage Ve while the first sustain discharge pulse applied to the first electrode continues, and applies the pulse width of the first sustain discharge pulse of the first electrode longer than those of the other sustain discharge pulses. Preferably, the period of the first sustain discharge pulse before stopping the application of the fourth voltage Ve is shorter than the period thereof after stopping the application of the fourth voltage Ve.

FIG. 4 is a driving waveform diagram of a plasma display device according to another embodiment.

The method is similar to the embodiment in FIG. 3. The pulse width of the first sustain discharge pulse applied to the scan electrode Y is longer than those of the other sustain discharge pulses, and the first sustain discharge pulse is partially overlapped with the interval where the fourth voltage Ve is applied to the sustain electrode X.

However, contrary to the embodiment of FIG. 3, the rising interval of the first sustain discharge pulse of the scan electrode Y is applied in a ramp waveform, and the application of the fourth voltage is stopped near the time the first sustain discharge pulse reaches peak value. In some embodiments, the application of the fourth voltage is stopped substantially at the same time the first sustain discharge pulse reaches peak value.

In order to apply such a driving waveform, the controller 20 applies the rising interval of the first sustain discharge pulse of the first electrode in a ramp waveform, and stops the application of the fourth voltage Ve near the time when the first sustain discharge pulse reaches the peak value.

Accordingly, the sustain discharge pulse applied to the scan electrode Y for the sustain discharge interval overlaps the fourth voltage Ve applied to the sustain electrode X for a period so that counter discharge between the Y electrode and the A electrode occurred during the sustain discharge period can be reduced.

The foregoing detailed description has been provided for the purpose of explaining the principles of the organic light emitting display of the invention and some of its practical application. The foregoing detailed description is not intended to be exhaustive or to limit the invention to the precise embodiments disclosed. Modifications and equivalents will be apparent to practitioners skilled in this art.

What is claimed is:

1. A method of driving a plasma display panel, the display panel including a plurality of first electrodes, a plurality of second electrodes, a plurality of third electrodes, the third electrodes formed in a direction substantially perpendicular to the first electrodes and the second electrodes, and a plurality of discharge cells each formed near an intersections of the third electrodes and the first and second electrodes, the method comprising:
resetting the discharge cells by applying a waveform to the first electrode;
applying a fourth voltage to the second electrodes;
selecting cells to be discharged by applying a scan pulse voltage to each of the first electrodes and the third electrodes corresponding to cells to be selected;
alternately applying a plurality of sustain discharge pulses having a first voltage as a peak value to each of the first electrodes and the second electrodes; and
during the first sustain discharge pulse applied to the first electrodes, stopping the application of the fourth voltage to the second electrodes.

2. The driving method of the plasma display panel as claimed in claim 1, wherein stopping the application of the fourth voltage to the second electrodes comprises applying a ground voltage to the second electrodes.

3. The driving method of the plasma display panel as claimed in claim 1, wherein the fourth voltage is greater than a ground voltage and less than the first voltage.

4. The driving method of the plasma display panel as claimed in claim 1, wherein alternately applying the sustain discharge pulses comprises applying the pulse width of the first sustain discharge pulse of the first electrodes longer than the other sustain discharge pulses.

5. The driving method of the plasma display panel as claimed in claim 1, wherein the stopping the application of the fourth voltage comprises stopping the application of the fourth voltage before the first sustain discharge pulse of the first electrodes reaches ½ of the corresponding pulse width.

6. The driving method of the plasma display panel as claimed in claim 1, further comprising applying the first voltage to the first electrodes during a reset period.

7. A method of driving a plasma display panel, the display panel including a plurality of first electrodes, a plurality of second electrodes, a plurality of third electrodes, the third electrodes formed in a direction substantially perpendicular to the first electrodes and the second electrodes, and a plurality of discharge cells each formed near an intersections of the third electrodes and the first and second electrodes, the method comprising:
resetting the discharge cells by applying a waveform to the first electrode;
applying a fourth voltage to the second electrodes;
selecting cells to be discharged by applying a waveform to the first electrodes and the third electrodes corresponding to cells to be selected;
alternately applying a plurality of sustain discharge pulses to each of the first electrodes and the second electrodes; and
stopping the application of the fourth voltage at substantially the same time the first sustain discharge pulse applied to the first electrodes reaches its peak value.

8. The driving method of the plasma display panel as claimed in claim 7, wherein stopping the application of the fourth voltage to the second electrodes comprises applying a ground voltage to the second electrodes.

9. The driving method of the plasma display panel as claimed in claim 7, wherein the fourth voltage is greater than the ground voltage and less than the first voltage.

10. The driving method of the plasma display panel as claimed in claim 7, wherein alternately applying the sustain discharge pulses to each of the first electrodes comprises applying a first sustain discharge pulse to the first electrodes, wherein the first sustain discharge pulse has a duration longer than the duration of the other sustain discharge pulses applied to the first electrodes.

11. The driving method of the plasma display panel as claimed in claim 7, further comprising applying the pulse of the first sustain discharge pulse of the first electrodes for a longer duration than the duration of the other sustain discharge pulses applied to the first electrodes.

12. The driving method of the plasma display panel as claimed in claim 7, further comprising applying another voltage to the first electrodes during a reset period, the other voltage having substantially the same value as the peak voltage of the first sustain discharge pulse applied to the first electrodes.

13. A plasma display device, comprising:
a plasma display panel, comprising:
a plurality of first electrodes;
a plurality of second electrodes;
a plurality of third electrodes the third electrodes formed in a direction substantially perpendicular to the first electrodes and the second electrodes; and
a plurality of discharge cells each formed near an intersections of the third electrodes and the first and second electrodes; and
a driving apparatus configured to:
apply a fourth voltage to the second electrodes;
alternately apply a plurality of sustain discharge pulses, each having a first voltage as a peak value to each of the first electrodes and the second electrodes; and
during the first sustain discharge pulse applied to the first electrodes, stop the application of the fourth voltage to the second electrodes.

14. The device as claimed in claim 13, wherein the driving apparatus is configured to stop the application of the fourth voltage to the second electrodes by applying a ground voltage to the second electrodes.

15. The plasma display device as claimed in claim 13, wherein the fourth voltage is greater than the ground voltage and less than the first voltage.

16. The plasma display device as claimed in claim 13, wherein the driving apparatus is configured to apply the pulse of the first sustain discharge pulse of the first electrodes for a longer duration than the duration of the other sustain discharge pulses.

17. The plasma display device as claimed in claim 13, wherein the duration of the first sustain discharge pulse before stopping the application of the fourth voltage is shorter than the duration thereof after stopping the application of the fourth voltage.

18. The plasma display device as claimed in claim 13, wherein the driving apparatus is configured to apply the rising portion of the first sustain discharge pulse to the first electrodes in a ramp waveform.

19. The plasma display device as claimed in claim 18, wherein the driving apparatus is configured to stop the application of the fourth voltage at substantially the same time the first sustain discharge pulse applied to the first electrodes reaches its peak value.

20. The devices as claimed in claim 13, wherein the driving apparatus is configured to apply the first voltage to the first electrodes during a reset period.
